(19) United States
(12) Patent Application Publication
(10) Pub. No.: US 2025/0001796 A1
(43) Pub. Date: Jan. 2, 2025

(54) ARTICLE HAVING A REUSABLE WRITING SURFACE

(71) Applicant: Wipebook Corp., Carp (CA)

(72) Inventor: Francois BOUCHARD, Ottawa (CA)

(73) Assignee: Wipebook Corp., Carp (CA)

(21) Appl. No.: 18/884,432

(22) Filed: Sep. 13, 2024

Related U.S. Application Data
(63) Continuation of application No. 18/767,676, filed on Jul. 9, 2024.
Application No. 18/767,676 is a continuation of application No. 17/530,280, filed on Nov. 18, 2021, now Pat. No. 12,054,002.
Application No. 17/530,280 is a continuation of application No. 14/498,904, filed on Sep. 26, 2014, now abandoned.

(30) Foreign Application Priority Data
Feb. 13, 2014 (CA) 2842734

(51) Int. Cl. B43L 1/00; B42D 1/00

(52) U.S. Cl. CPC B43L 1/00; B42D 1/008

(57) ABSTRACT

There is provided an article having a reusable writing surface comprising: a planar surface, a water-based film disposed upon the planar surface, wherein the water-based film has a satin finish, and a first UV film over the water-based film, wherein the first UV film has a gloss finish, thereby providing a surface suitable for writing with a dry erasable pen and allowing erasure of the writing.

### CROSS-REFERENCE TO RELATED APPLICATIONS

The present application is a Continuation of U.S. patent application Ser. No. 18/767,676, filed on Jul. 9, 2024, which is a Continuation of U.S. patent application Ser. No. 17/530,280, filed on Nov. 18, 2021, which is a Continuation of U.S. patent application Ser. No. 14/498,904, filed on Sep. 26, 2014, which claims priority to Canadian Patent Application No. 2842734 filed on Feb. 13, 2014.

### FIELD OF THE INVENTION

The present invention relates to articles having erasable surfaces.

### BACKGROUND OF THE INVENTION

There are known articles such as workbooks having pages with at least a portion thereof bearing an erasable surface. Typically, these include children's books for practicing printing or drawing. One such example is EP 0309106 (B1) published Nov. 13, 1991.

Other offerings include hybrid articles combining a dry-erasable panel along with paper pages. One example is U.S. Patent Pub. 20120129146.

### SUMMARY OF THE INVENTION

An object of the present invention is to provide an improved article having a reusable writing surface.

In accordance with an aspect of the present invention there is provided article having a reusable writing surface comprising at least one writing surface upon which a dry-erasable pen can write and be erased for repeated use of the writing surface.

### BRIEF DESCRIPTION OF THE DRAWINGS

The present invention will be further understood from the following detailed description with reference to the drawings in which:

FIGS. 1a and 1b illustrate a writing kit having a workbook (FIG. 1a) and marker (FIG. 1b) in accordance with an embodiment of the present invention;

FIGS. 2a and 2b illustrate examples of two workbooks of FIG. 1 a having different form factors;

FIG. 3 illustrates an article having a reusable writing surface such as a workbook page of the workbook of FIG. 1; and

FIG. 4 illustrates in a partial cross-section through line 4-4 of the workbook page of FIG. 3.

### DETAILED DESCRIPTION OF THE PREFERRED EMBODIMENT

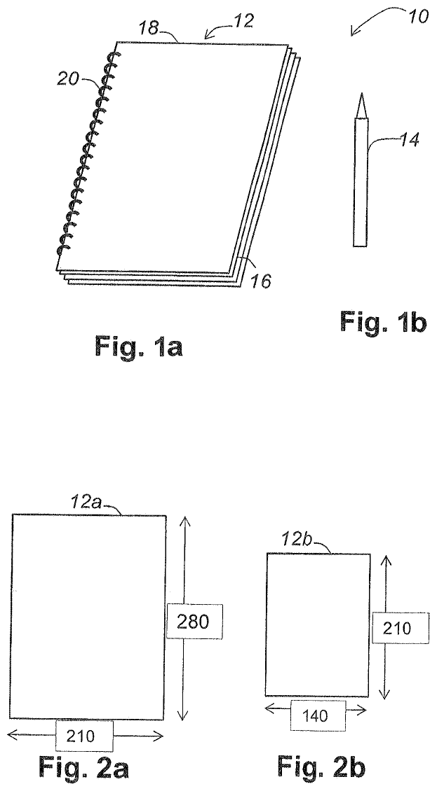

Referring to FIGS. 1a and 1b there is illustrated a writing kit having a workbook (FIG. 1 a) in accordance with an embodiment of the present invention. The workbook kit 10 includes a workbook 12 and a dry erasable marker or correctable marker 14 (FIG. 1b). The workbook 10 includes a plurality of pages 16 and may include a cover 18 bound together with a binding 20. The binding 20 can be a spiral binding, a plastic comb binding, an operable binding or one having an open state and a closed state. An example of the latter binding is the GBC® PROCLICK® binding manufactured by General Binding Corporation of Northbrook III., which can be opened to allow pages to be added and removed for photocopying or scanning, then closed for use of the workbook.

The dry erasable marker 14 may be any non-permanent dry erase pen. A particularly suitable marker is a hybrid marker, for example a LUMOCOLOR® correctable 305 non-permanent dry erase pen by Staedtler Mars Limited of Mississauga, Ontario.

Referring to FIGS. 2a and 2b there is illustrated examples of two workbooks of FIG. 1a having different form factors. The two examples are a letter sized notebook 12a and a note pad 12b. The dimensions are shown in millimeters. The workbook 12a is 280 mm by 210 mm. The workbook 12b is 210 mm by 140 mm. While two examples are shown, the workbook 12 can be prepared in many different sizes depending upon the desired purpose of the workbook.

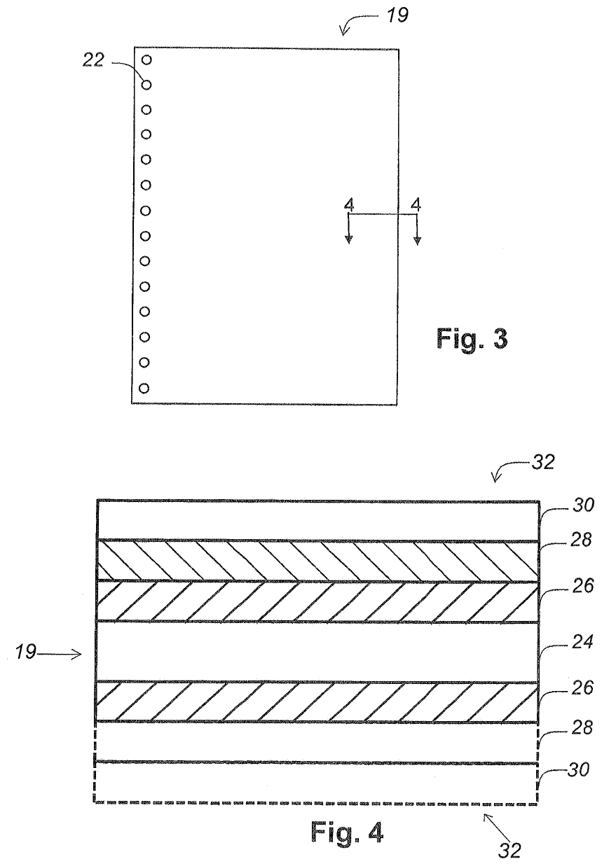

Referring to FIG. 3 there is illustrated a workbook page 19 of the workbook of FIG. 1a. The workbook page 19 includes at least one face upon which a dry erasable pen may be used to write. The writing face includes a layer of sheet material that provides a good writing surface and also allows erasure of the writing for repeated use of the workbook page. One margin of the workbook page 19 includes perforations 22 for receiving the binding 20. The binding 20 may be any suitable binding, for example a metal or plastic spiral binding, a plastic comb binding or an operable binding. While the perforations 22 are illustrated as circular, it will be appreciated that the perforations may be of different shape to accommodate alternative bindings.

Referring to FIG. 4 there is illustrated in a partial cross-section through line 4-4 of the workbook page of FIG. 3. The workbook page 19 includes a substrate 24 having a coating 26 on both first and second surfaces. The substrate may be selected from the group consisting of: paper, coated paper, cardboard, coated cardboard, cardstock, coated cardstock and synthetic sheet material. At least one surface includes an intermediate layer 28 and a writing surface layer 30 to provide a writing surface 32. The workbook page 19 may be single sided as shown in FIG. 4, or may optionally have a writing surface on the second face as illustrated by broken line in FIG. 4.

Details of the layers are as follows. The substrate 24 of the present embodiment is a conventional paper medium, however any suitable substrate including cardboards, card stocks, and synthetics could also be used. The paper substrate 24 was coated on both surfaces with a water-based film 26, that is the substrate 24 with the water-based film 26 was a coated paper. The water-based film had a satin finish. The writing surface 32 was prepared by applying two layers 28 and 30 to at least one surface of the water-based film 26. The layers 28 and 30 were UV films. In one example the layer 28 is a water-based UV film and the layer 30 is another UV film having a gloss finish.

Specific examples of the latter film are UV 9296 and UV 9613 by Actega Kelstar Canada Inc., of Chomedey Quebec.

Alternative embodiments may use known paper-based substrate coated with film. Synthetic substrates may be selected that do not require a coating layer, in which case the coating layer 26 is omitted.

The workbook may includes pages on which one of the substrate, the first UV film and the layer there between includes printed matter, for example grids, lines, polar plots, music staff, guitar tablature and bass tablature.

Numerous modifications, variations and adaptations may be made to the particular embodiments described above without departing from the scope patent disclosure, which is defined in the claims.

1. An article having a reusable writing surface comprising:
a planar surface;
a water-based film disposed upon the planar surface, wherein the water-based film has a satin finish; and
a first UV film over the water-based film, wherein the first UV film has a gloss finish, thereby providing a surface suitable for writing with a dry erasable pen and allowing erasure of the writing.

2. The article of claim 1, further comprising a second UV film between the water-based film and the first UV film.

3. The article of claim 2, wherein the second UV film has the same composition as the first UV film.

4. The article of claim 2, wherein the second UV film has a different composition than the first UV film.

5. The article of claim 2, wherein the second UV film has a matte finish.

6. The article of claim 1, wherein one of the planar surface, the first UV film and the water-based film includes printed matter selected from the group consisting of: grids, lines, polar plots, music staff, guitar tablature and bass tablature.

7. The article of claim 5, wherein one of the planar surface, the first UV film, the second UV film, and the water-based film includes printed matter selected from the group consisting of: grids, lines, polar plots, music staff, guitar tablature and bass tablature.
